(19) United States
(12) Patent Application Publication
(10) Pub. No.: US 2014/0317681 A1
(43) Pub. Date: Oct. 23, 2014

(54) CLOUD FORENSICS

(71) Applicant: Jon Rav Gagan Shende, (US)

(72) Inventor: Jon Rav Gagan Shende, Highlands Ranch, CO (US)

(21) Appl. No.: 14/215,618

(22) Filed: Mar. 17, 2014

Related U.S. Application Data
(60) Provisional application No. 61/799,535, filed on Mar. 15, 2013.

(51) Int. Cl. H04L 29/06

(52) U.S. Cl. CPC H04L 63/10
USPC 726/1

(57) ABSTRACT

The cloud forensic system provides a method and system for generating an instance from a client cloud computing environment, wherein the instance is generated without affecting the integrity of the client cloud computing environment; generating a baseline of the client cloud computing environment; benchmarking the instance based on comparison of the instance to the baseline; verifying the benchmark based on a client policy; and retiring the instance, if the benchmark is verified.

### CROSS-REFERENCE TO RELATED APPLICATIONS

The present application claims benefit of priority to U.S. Provisional Patent Application No. 61/799,535 entitled “Cloud Forensics” and filed on 15 Mar. 2014, which is specifically incorporated by reference herein for all that it discloses or teaches.

### FIELD

Implementations disclosed herein relate, in general, to the information management technology and specifically to technology for providing forensic services.

### SUMMARY

The cloud forensic system provides a method and system for generating an instance from a client cloud computing environment, wherein the instance is generated without affecting the integrity of the client cloud computing environment; generating a baseline of the client cloud computing environment; benchmarking the instance based on comparison of the instance to the baseline; verifying the benchmark based on a client policy; and retiring the instance, if the benchmark is verified.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 is an example flow diagram of a cloud forensic system disclosed herein.

FIG. 2 is an example block diagram of a verification engine access and log mechanism.

FIG. 3 is an example flow diagram of an instance gathering process.

FIG. 4 is an example flow diagram of a data disposition process.

FIG. 5 is an example flow diagram of a data retention and disposition process.

FIG. 6 is an example flow diagram of an instance verification process.

FIG. 7 is an example flow diagram of a verification fail management process.

FIG. 8 is an example of a user analytics process.

FIG. 9 is an example of an instance analytics engine.

FIG. 10 is an example depiction of the platform from an end-user perspective.

FIG. 11 illustrates an example flow diagram of a time specific repository.

FIG. 12 illustrates an example flow diagram of an instance storage management process.

FIG. 13 illustrates an example flowchart for providing cloud forensics.

FIG. 14 illustrates an example network environment for implementing the information cataloging system disclosed herein.

FIG. 15 illustrates an example computing system that can be used to implement the recommendation system disclosed herein.

### DETAILED DESCRIPTION

In today's dynamic information technology systems, one area of tremendous focus and recent growth has been that of the cloud-computing model in its various offerings. With this growth however come new challenges within the realms of e-discovery and digital forensics, as we know it. A cloud forensic system disclosed herein allows users to provide digital forensics and provide data integrity within a cloud ecosystem. This system takes into consideration the volume of data as it grows with an increased usage of cloud technologies with allowances for analysis impacted by scale as well as key user criteria per industry and compliance with mandatory regulations. For example healthcare data that may be inadvertently disclosed in social media platforms that may be in breach of the HIPAA privacy and security rules or data publish from the hack of a retailer that can be used to commit financial crimes against a select user group.

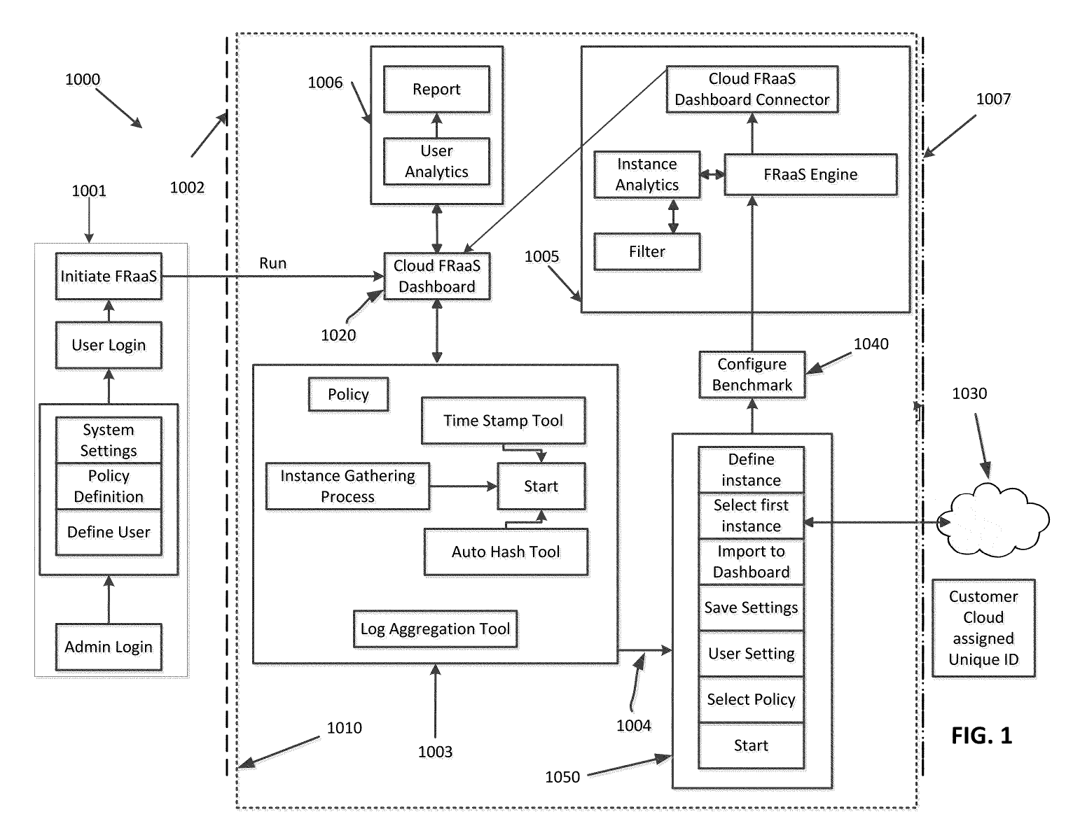

FIG. 1 is an example flow diagram of a cloud forensic as a service (FRaaS) system 1000 disclosed herein. This is an overview of the cloud forensics system as it functions from connect, select, configure, and execute to run with sub-processes detailed in identified areas following. The outcome or requested reports from this system provide key information on actions that occur within a cloud services ecosystem. The cloud FRaaS system 1000 is designed to provide the assurance of verified: access, logs, timestamps, aggregation and correlation engines, data analysis with verification and reporting, as well as the assurance of a strict chain of custody within the virtual environment for both internal and external users of the system. Reports from the cloud FRaaS system 1000 can be presented in a court of law in the form of irrefutable evidence for instance in the case of retailer, manufacturer, e-commerce or any other instance where a crime has been committed that touches technology and leaves electronic fingerprints, signatures and trails. In one implementation, the administrative settings are configured in block 1001 based on either a predefined access control policy imported from the users' company directory with predefined privileges. Alternatively an administrator of the cloud FRaaS system 1000 has the option to create users for the system based on pre-determined criteria, which can then be imported into pre-defined user templates, again based on privilege level and appropriate access controls bounded by user logs. An administrator for the cloud FRaaS system 1000 may have to present verification from their company's legal and HR teams along with authorization and appropriate clearance levels defined in a legal document.

The block 1001 is segmented from a core FRaaS platform, block 1010 by a logical firewall 1002 governed by strictly monitored firewall rules, centralized logging and automation, etc. The core FRaaS platform, block 1010 is bounded by the logical firewalls 1002 and 1007 with 1007 being another secured segmentation into the FRaaS platform, block 1010 for a cloud customer. Once the system is initiated and all authorizations for access and use, verified and logged, end users have an ability to execute projects within the core FRaaS platform, block 1010 and are presented with an easy to use dashboard environment.

On start the system, an Instance Gathering Process (IGP) module, block 1003 within the core FRaaS platform, block 1010 initiates an Instance Gathering Process (IGP). The IGP module, block 1003 has an integrated time stamp tool, with auto hashing capabilities as well as a log aggregation tool. In one implementation, the IGP module, block 1003 is governed by a policy which can be used is a preconfigured state or alternatively can be edited by a system administrator. This function is further defined by block 1004, which demonstrates how the system setting flows as it leads to selecting an instance. This from configuring a policy to defining the first instance which serves as a benchmark and then starting the Cloud FRaaS platform, block 1010 to execute services within a FRaaS engine, block 1005. The FRaaS engine, block 1005 houses proprietary algorithms which include proprietary instance analytics, filtering and output to reporting within a cloud FRaaS dashboard, block 1020 of the FRaaS platform. 1006, the cloud FRaaS dashboard, block 1020 also provides an option for an administrator to gauge user analytics in addition to system reporting.

The core FRaaS platform, block 1010 may serve a customer cloud, block 1030, which is separated from the core FRaaS platform, block 1010 by a firewall 1007. Each customer cloud, block 1030 may be assigned a unique identification within the core FRaaS platform, block 1010.

In one implementation, a cloud FRaaS administrator is assigned customers segments by geographic location based on the cloud customer main headquarter location. This administrator may be provided access to a copy of the cloud FRaaS and cloud customer's master service agreement (MSA) with legal authorization and verification of two company assigned administrators. These customer assigned administrators are allowed access rights to configure customer policy for their environment by the cloud FRaaS administrator. Once customer administrative assignments are completed and the cloud customer's unique cloud FRaaS ID is set up within the system; the assigned cloud FRaaS administrator opens a ticket to start creating and configuring an environment for the cloud customer's integration with the cloud FRaaS platform. Based on the content of the MSA the cloud FRaaS administrator may configure restricted cloud customer administrators use policies as well as set access for the administrators to select, configure and set up functional cloud FRaaS policies specific to their environments.

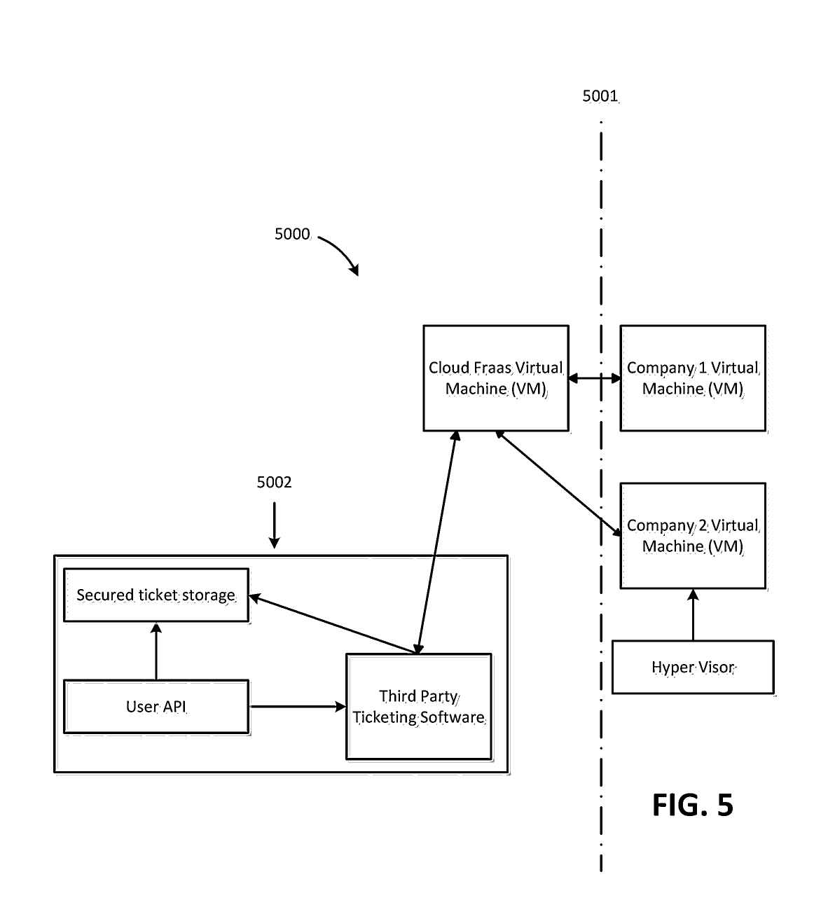

Once these cloud customer administrative settings are saved, they may not be changed unless a written request is sent from the cloud customer's legal department requesting change or a change request is created from our ticketing system described in FIG. 5, with attached document/s from the legal supporting such a request for change. One or more cloud customer administrators can then add their own users for the cloud FRaaS platform and have user policy templates to leverage in building profiles and configuring access and usage controls. The users have access to the cloud FRaaS dashboard 1020; however cloud customer administrators have access to policy selection, setup configuration, editing, monitoring and reporting that everyday users of the cloud FRaaS platform may not. Cloud FRaaS administrators also have the access that a cloud customer administrator has to the system as well as additional granular access to monitor the movements and usage of administrators.

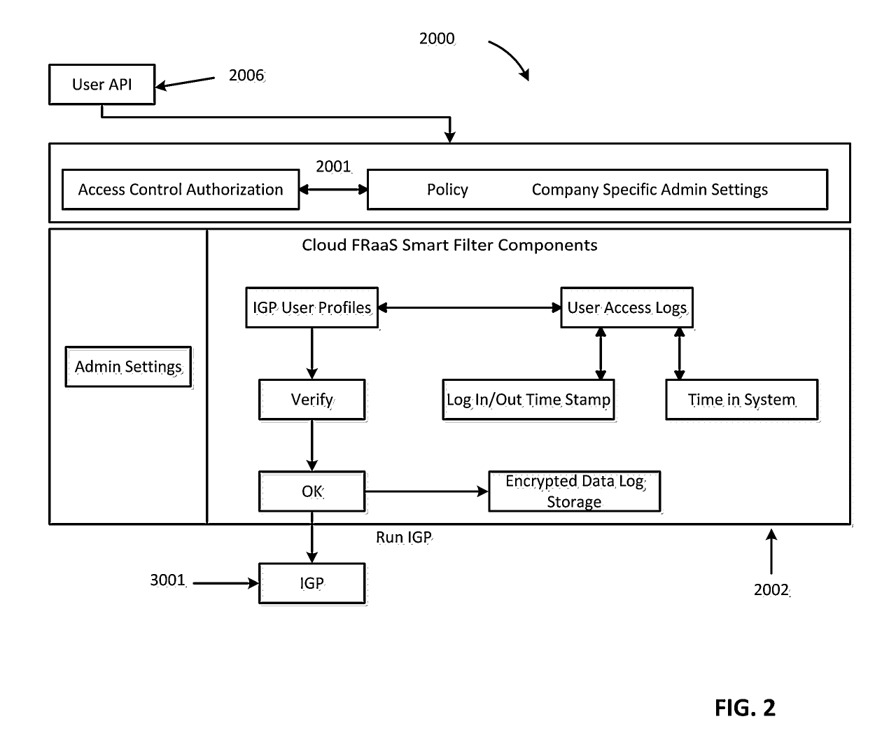

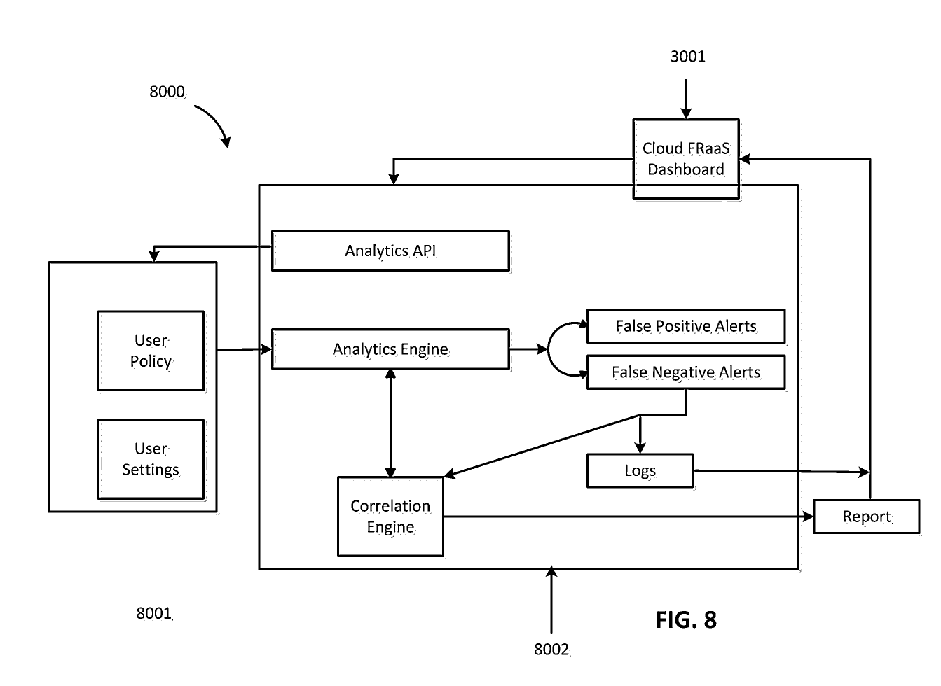

Furthermore, cloud FRaaS administrators also receive reports on use change that vary from a set pattern from user policy, user settings shown in FIG. 2 and the user settings and aligned analytics engine shown in FIG. 8, with transparency up to the cloud customer administrators. After a cloud customer administrator completes the set up of a user for the cloud FRaaS environment, users can immediately begin to hook into their cloud environment, extract and/or monitor instances within their cloud environments per policy settings. In the initial boot up, a benchmark for instances to be monitored is established. The cloud customer user of the cloud FRaaS environment is provided guidelines to select, and define a first extracted instance to act as an initial benchmark with which to detect unauthorized changes to the customer's cloud environments.

The type of changes a customer is looking for may be defined in the cloud customer's administrators policy set up and configure segment shown in blocks 1001 for the main setup to include cloud customer administrator setup and block 1050 as detailed above. Configuring an instance benchmark, block 1040 is designed to be a simple 5 click process. One objective of this block is to ensure that a user leverages a defined policy from block 1050 and then extract their first instance from the customer cloud environment 1030 to be tagged a benchmark. As a result, this instance may become the first instance within a new environment that allows for virtual operations and transaction to occur. In the event the cloud customer's request is to monitor a cloud environment that is already operational, a system verification check may be provided by the cloud provider with an attestation that no malicious entities are currently residing in this operational system.

Subsequently, a policy is configured which aligns with a first instance extraction, which is configured as a benchmark system. The monitoring initiates from that time and it is categorized and logged as cloud FRaaS operator start. The cloud FRaaS platform 1010 is cloud system agnostic and integrates with all currently available cloud environments e.g. environments provided by Apache, Microsoft, Amazon, Apple, Citrix, Google, VMware, Rackspace etc. The processes embedded in the block 1050, include authorizing a user, user access verification, logging user into cloud FRaaS system 1000, selecting cloud environment, selecting an instance to be monitored or various instances to be monitored, starting the monitoring function within the cloud FRaaS dashboard, block 1020, etc.

FIG. 2 is an example block diagram of a verification engine 2000 that provides access and log mechanism. The verification engine 2000 illustrates the level of granularity that the cloud FRaaS system offers in administrative set up and in user configuration set up. An API 2006 provides an entry to the Cloud FRaaS system and is built to meet NIST SP 800 series for web security as well as guidelines from Open Web Application Security Project (OWASP). In one implementation, the API 2006 provides an end-to-end encrypted process. In block 2001, the settings may follow a strict protocol of policy configuration aligned with user privilege that can be aligned with the end user company's access control policies or customer configured through the Cloud FRaaS administrative settings.

Block 2002 shows how the system allows cloud customer administrators to set up reporting views as well as configure user profiles in the system. Due to the nature of the system, chain of custody is important. Therefore, in the implementation illustrated herein the cloud customer administrators are able to configure how they receive users access, time-in and time-out of the system verification reporting, the number of log in attempts for a session, the number of failed logins, the locations where the users log-in from based on IP addressing, the locations where a user spent an excessive time in the system, etc. In one implementation, one or more of these functions are configured with smart filters embedded in the cloud FRaaS dashboard, block 1020 and is configured for ease of use with a simple to use API.

Block 2002 also demonstrates a process that is aligned with an administrative policy for the FRaaS platform and is not be editable once confirmed and in use. Block 2002 attests to a user's footprint when within the system and can be extracted securely and unchanged for chain of custody requirements. User verification fail attempts are logged and sent encrypted to a secure storage area for holding and investigation.

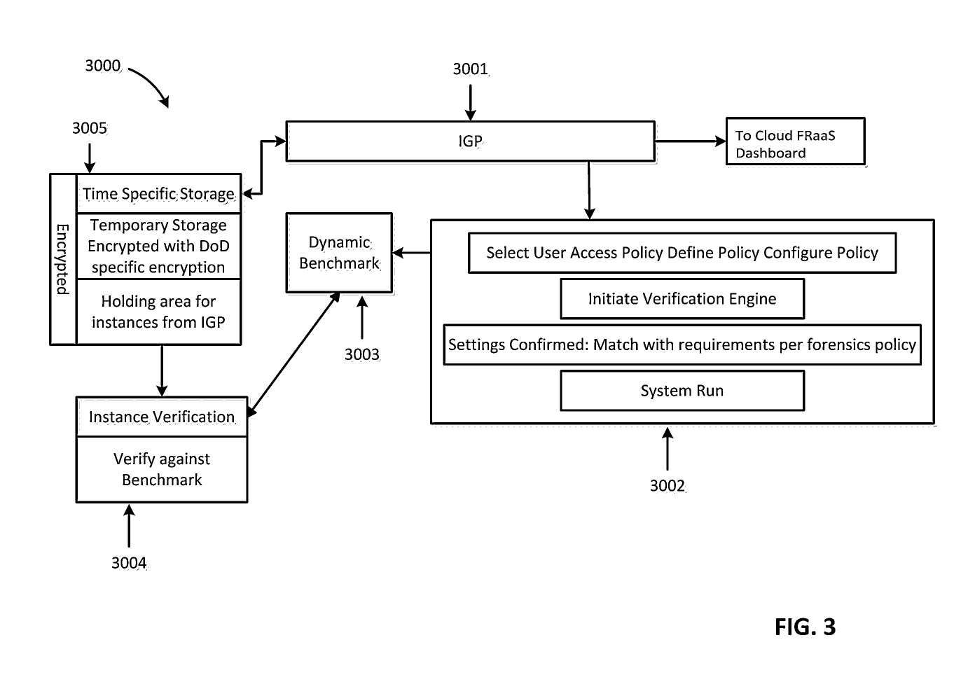

There are defined templates within this segment connected to modules that are controlled by a smart filter. Each defined template can be populated with user access based on their level of clearance and privilege. For integrity and chain of custody requirements, all logs are hashed and kept in a physically separated encrypted data log storage area, which is auditable. In one implementation, auditors have access to log storage environment thorough a pre-configured API located within the cloud FRaaS dashboard, block 1020. Access to this dashboard may be by administrator approval only and may need to be authorized by the cloud company's legal or audit department, or by a subpoena from an external legal body. Audits on logs are carried out on a fixed basis. The cloud FRaaS system has a pre-configured policy for log audits and allows the cloud customer administrator to configure audits by number of days, weeks and monthly. The cloud FRaaS audit configuration is set to weekly by default, however, it can be changed by a user. Block 2002 is connected to an Instance Gathering Process (IGP), block 3001 as illustrate in FIG. 3.

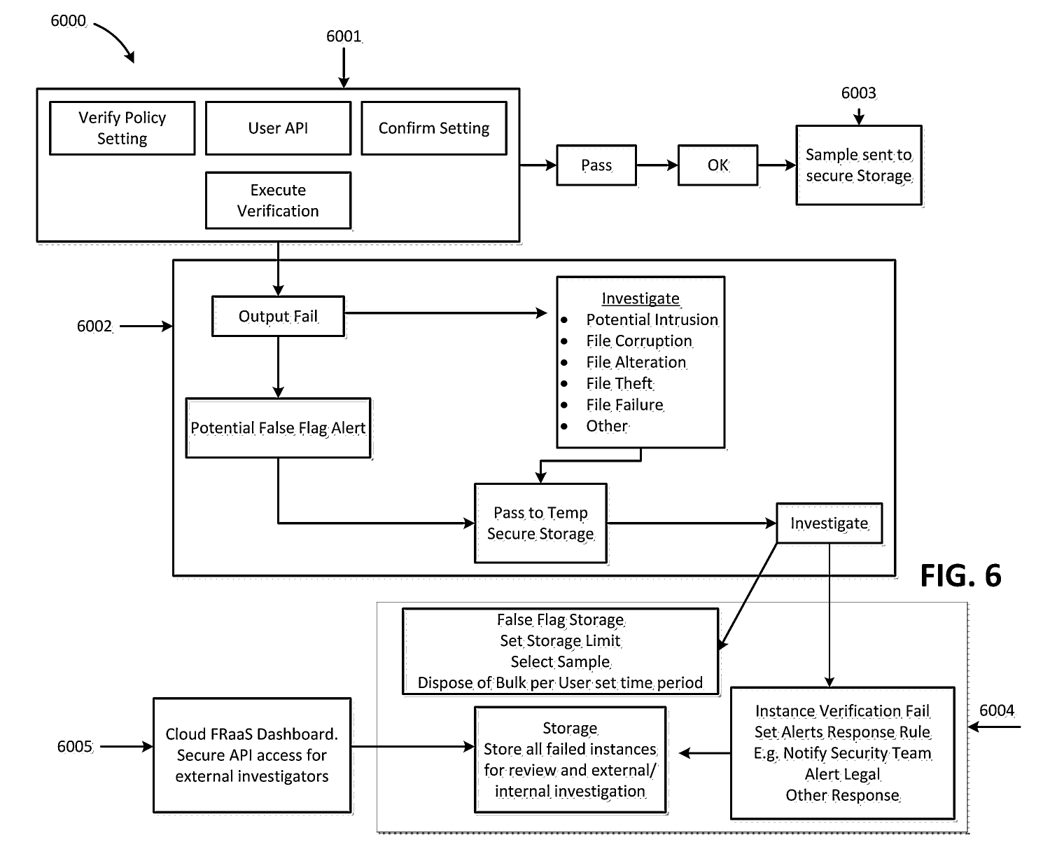

FIG. 3 is an example flow diagram of an instance gathering process 3000. An IGP block 3001 is interconnected with block 3002 that provides user access policy, how a user is defined, etc., to interact within the FRaaS system based on requirements from the users' company, their company agreed upon system settings and level of escalation privilege. FIG. 3 demonstrates how the process flows from the user verification and user confirmation in block 3002 before system is run, again to ensure a defined chain of custody. A smart system block 3003 scales per cloud usage volume to offer dynamic benchmarking The process also flows to an instance verification process block 3004. In one implementation, block 3004 may be built from the baseline criteria established within blocks 1040 and 1050 from FIG. land is presented in more details in FIG. 6 and detailed further in blocks 6001, 6002, 6003, and 6004, therein.

Dynamic benchmarking is an important component within the cloud FRaaS system, because, with the cloud ecosystem and any related Big Data environments, the volume of data can grow very quickly or scale-up rapidly. With the cloud FRaaS being deployed into a cloud ecosystem, which can then be interconnected with any Big Data system in today's operational environments, the ability of the cloud FRaaS platform to rapidly assess the volume of instances being selected and under monitor, is important to ensure correct processing, instance monitoring management, and instance verification processing. The dynamic benchmarking system is a process tuned and backed by proprietary algorithms and smart filtering capabilities to ensure that the smart filter adjusts the functionality of the dynamic benchmarking process, so as to meet volume and scaling requirements—either scaling up in a high instance volume environment or being able to scale back in times of lower instance volumes. In one implementation, the dynamic benchmarking system correlates and aggregates instance volume into a dynamic work stream providing for multiple instance monitoring and verification within the instance verification process, as further illustrated in FIG. 6 herein. Integrity verified data from block 3004 is then transmitted to a secured storage area block 3005. Block 3005 also acts as a temporary holding area for instances under analysis and is time stamped for access, process, and transfer to long-term storage. A reporting module allows audit and external user access to the cloud FRaaS dashboard, block 1020.

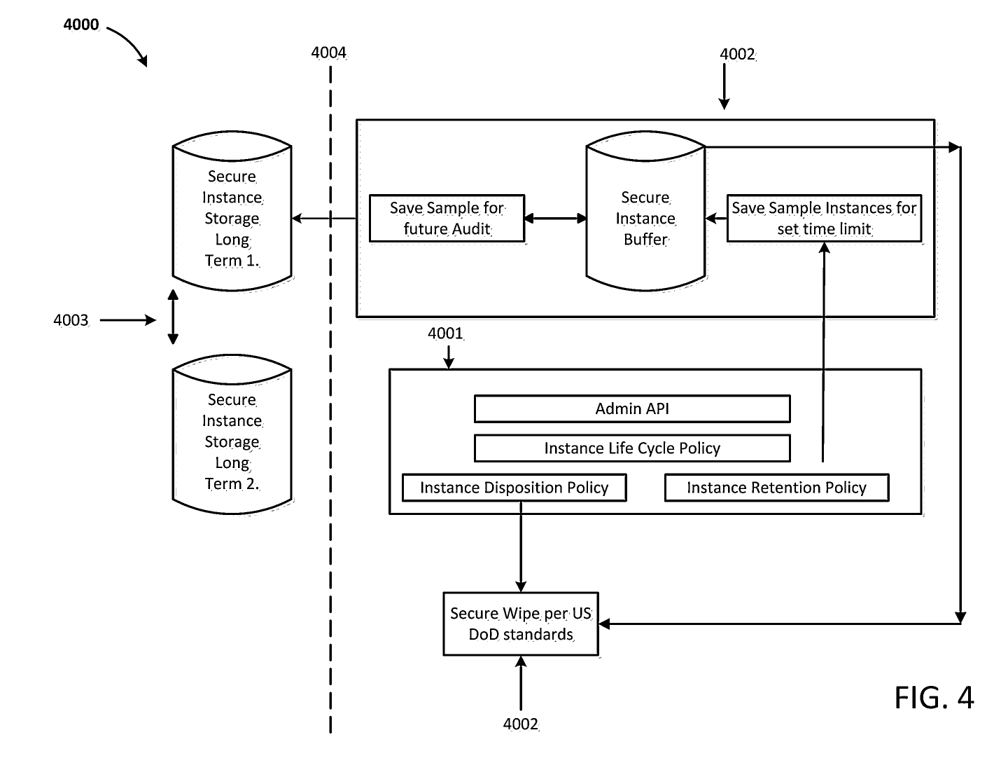

FIG. 4 is an example flow diagram of a data disposition process 4000. The data disposition process is a highly restricted environment. In one implementation, the cloud FRaaS platform only allows access to this module to two company verified administrators and a Cloud FRaaS master administrator, who supports the customer administrators with configuration and setup processes only. Data is configured per settings within the data disposition policy. At block 4001, administrators may have the option to use pre-configured data disposition and policy templates or the administrators can configure a template to suit their company policies and need. Each instance also has a configuration per an instance life cycle policy, an instance retention policy to meet each customer need for instance storage time periods and an instance disposition policy.

The block 4001 is a living environment where, the instance life cycle policy moves with the flow of any one instance under monitoring as it is tagged with policy settings to either be disposed per a defined instance disposition policy, or retained per a defined instance retention policy. Actions for selecting either disposition or retention policy are set up by the cloud customer administrator leveraging, defined templates that come pre-configured within the cloud FRaaS platform or can be customized to meet their requirements based on the cloud company policies. Administrators and users of the customer cloud FRaaS environment have privileges to modify these policies as necessary, based on the status on any on instance under monitoring.

Block 4002 leverages configurations from the instance retention policy and sample selection of instances, with a secured instance buffer built in to allow for scale of volume. Samples are saved for legal, federal or law enforcement purposes in a secured long term storage facility that has built in failover and recovery capability. In the event that stored or sampled instances are to be deleted per policy, the system may wipe all selected stored and sampled instances as per US DoD wipe disk standards. Physical storage devices are wiped up to US DoD 5220.22-M data sanitation method. Block 5003 demonstrates two secure storage areas; they are functionally a primary and a failover storage segment. Data is securely transmitted from block 4002 into the secure storage are 4003, which is physically separated from block 4002 by a firewall 4004.

FIG. 5 is an example ticketing process 5000, illustrating the ticketing system diagram of a change management and control process. Using a secured API that requires two factor authentication only assigned administrators logging in from the customer environment can access a change request to be sent and remediated by a Cloud FRaaS administrator. An example of such a request could be a request to change a customer administrator or to work with a new customer administrator to get an administrator policy provisioned and activated. A logical firewall 5001 separates a customer cloud system from an embedded Cloud FRaaS service residing within a customer's cloud environment. Block 5002 demonstrates how an administrator can access secured storage integrated with a third party ticketing software system. This third party system may be external to the Cloud FRaaS platform and any engines that touch confidential data being monitored and is accessed via a secured API.

FIG. 6 is an example flow diagram of an instance verification process 6000. Users accessing the Cloud FRaaS platform operations in block 6001 may do so based on the settings of a verification policy. Daily samples of users that pass verification are taken and transmitted securely to a secure storage area as shown in block 2002 earlier for periodic audit. Block 6002 demonstrates the process that occur in the event that instance verification fails and list some examples of what may cause a known verification or false positive failure to occur. In one implementation, all instance failures are logged regardless of state and an alert is sent out to an assigned user and a customer cloud FRaaS administrator. The alert includes a link to a summary of the instance failure, inclusive of time and date, environment, customer ID, instance ID, user log ID and a rule set shown in block 6004, defining prescribed next steps or predetermined action based on a cloud customer policies or preconfigured response action configured, in the event of an instance failure.

This block 6004 also demonstrates a legitimate instance verification failure and the process path the system is configured to take per administrative settings and defined pre-set policies to initiate an investigation process. False positives are deleted but samplings of false positives are still kept for audit purposes. This precedes the initiation of an investigation process; this process can be configured to run automatically when a certain number of fail attempts are made and logged—a threshold level, or manually per a cloud customer administrator configuring a policy to alert the administrator that a specific threshold level has been reached. The administrator can then either manually investigate or set an auto run policy to execute based on the administrator acknowledging that an alert was received and authorizing an auto run investigate process. The cloud FRaaS platform comes preset with a policy to auto run per a set threshold level for failed verification attempts. Once an investigation is underway a pre-defined and configured response rule set, configured to run in block 6004, is activated. Data stored temporarily in secured storage are assessed based on impact (false flag, error, real threat etc.), which is defined in a cloud customer policy that is in turn aligned with the cloud customer requirements. This allows for an administrator working with an investigator to scale the volume and capacity for storage to ensure capacity is always available. This capacity is time specific and defined by a retention policy for investigations.

The secured area, where all failed and suspicious instances are kept, has a module that allows API access via another area within the cloud FRaaS dashboard, block 1020, where external investigators (law enforcement, federal, legal) can be verified and given access to reports and monitoring details. Access through this area 6005 is available in a segmented area of the cloud FRaaS dashboard, block 1020, and may require permission from both a cloud FRaaS administrator as well as a cloud customer, cloud FRaaS administrator. For example, in one implementation, access requires two-factor authentication and a legal document that will be uploaded and stored within an access approval repository defining the request for access.

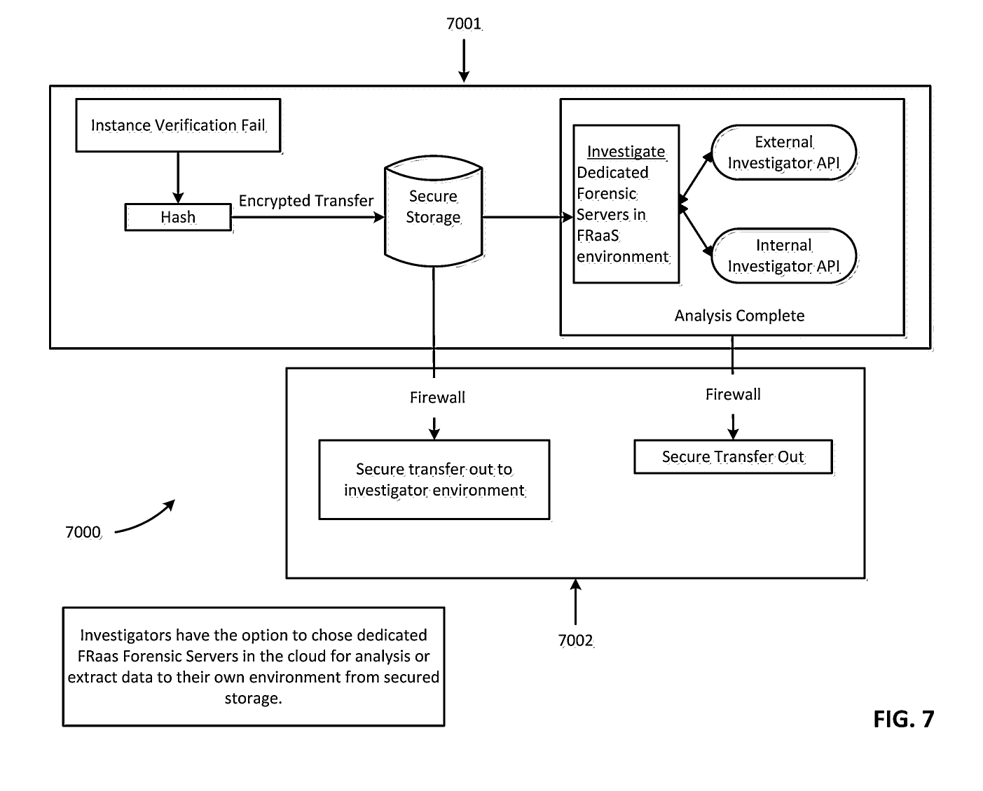

FIG. 7 is an example flow diagram of a verification fail management process 7000. This example expands on the verification fail processes identified in FIG. 6, block 7001 demonstrates what happens in the event of an instance fail. In order to ensure integrity and maintain a chain of custody an immediate hash of data from an instance fail event is taken and transmitted securely to a secured storage area. The hash is kept physically separated from any verification fail data as such data is queued for investigation either by an approved and verified external or internal investigator. Two means of access are provided for investigation of instance verification fail data. One is through the cloud FRaaS dashboard, block 1020 for internal users and will be tagged with the appropriate user access logs, verification logs, time in system logs and data access logs. The second method of access is through an API dedicated for external users of the system e.g. law enforcement personnel. In one implementation, these users may only have access to the forensic engine and forensic servers as shown in block 12004, as well as limited access to data within the system as defined by a policy for external investigators who will access data through a module within the cloud FRaaS dashboard, block 1020. Limited access means they may have to work with a dedicated cloud FRaaS administrator to obtain relevant data that their investigation required and defined in a subpoena. This also ensures that all actions within the system are trackable and follow strict chain of custody rules. Block 7002 shows where logical and physical firewalls reside within process 7000 secure and monitor access and data transfer.

FIG. 8 is an example of a user analytics process 8000. This process demonstrates how a verified user can access the instance analytics module. At block 8001, the user setting for this access is preconfigured by a customer administrator and users have no rights to make any changes to the system functionality, policy or settings. Block 8002 includes is a gateway API from within the cloud FRaaS dashboard block 1020, which gives a user insight into the analytics engine. A user logging into the system is automatically relayed through the user policy block 8001 for verification before being routed into the system and given access to the analytics and correlation engine functions. In one implementation, users cannot access these engines as they run seamlessly in the background however a user is able to access reports, logs and a summary for false positive and false negative alerts. However, the users can generate an in depth report of the functions and findings of the analytics and correlation engines together with logs and a summary of alerts. Each report allows the user to drill down from the summary on any one alert to get more information on any one alert. Reports, once created and saved, can be accessed directly from the cloud FRaaS dashboard, block 1020.

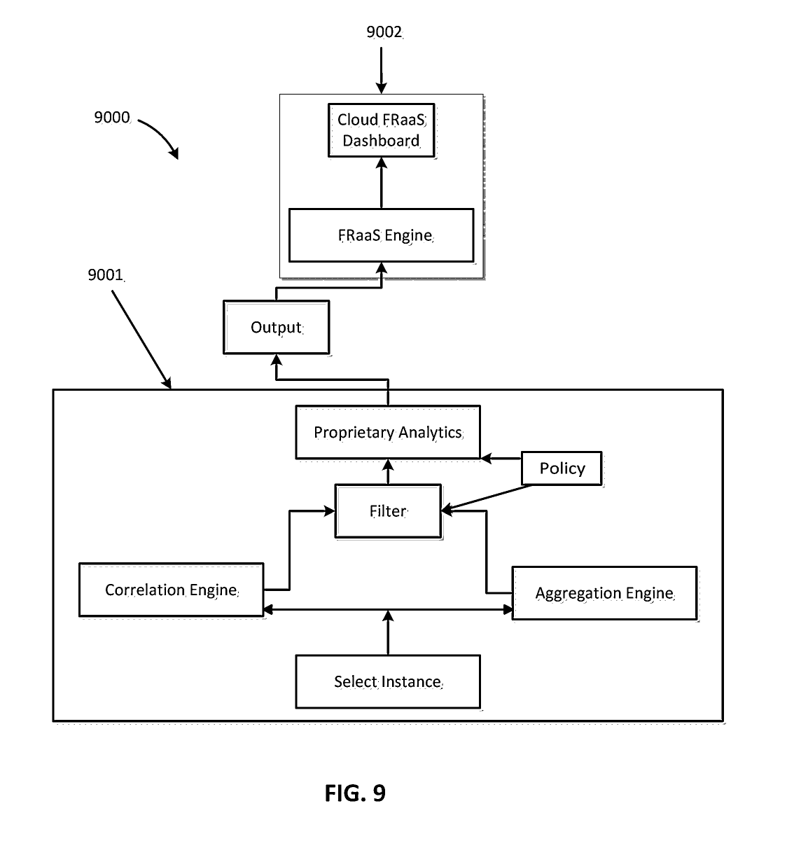

FIG. 9 is an example of an instance analytics engine 9000. Once an instance is selected and imported into the environment for monitoring, at 9001 both correlation and analytics engines execute in the background. Based on preconfigured policies, a cloud FRaaS system administrator settings align a functional policy which executes a system filter. This is a seamless and automated process that is set up by default in the cloud FRaaS configuration process. The filter will assess and sort data in motion within the cloud environment being monitored and passes it through a propriety analytics engine. This engine 9000, integrated with the instance verification process, sorts, categorizes tags and presents output. The results of the engine 9000 are communicated to the FRaaS engine, connected to the cloud FRaaS dashboard block 9002, seen in more detail earlier within FIG. 1 block 1005, which connects to the cloud FRaaS dashboard, block 1020. The underlying functions that occur within the Cloud FRaaS system may be governed by proprietary algorithm and a user will not have access to these underlying functions as they occur in block 9001.

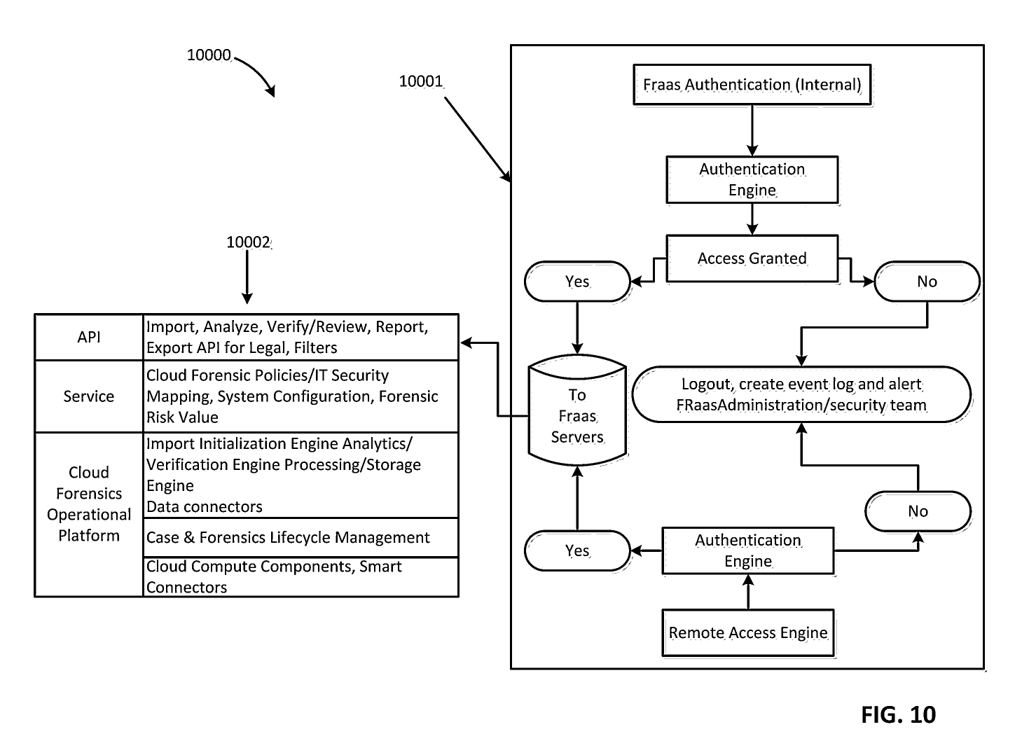

FIG. 10 is an example of a workflow demonstrating how the Cloud FRaaS system grants access, as illustrated by block 10001, to both internal and external users, as well as an overview of how the architecture of the system is built, how it leverages its services and execute functions block 10002, from its platform to it service operations to the end user API for import, analyze, verify/review, reporting etc. An API found within the cloud FRaaS dashboard block 1020. Block 10002 is an example of how the system is built defining its operation platform that contains import functions, analytics engines, verification engines, processing components, monitoring services, data connectors, cloud compute components, smart filter engines and forensic lifecycles management systems, etc. Services within block 10002 are built upon the platform that map to policies, services and system configurations, forensic risk values, alignment with IT security, etc. Furthermore, the actual front end that a user logs into and works from, is layered on top of the services platform in the form of the cloud FRaaS dashboard, block 1020, with integrated APIs.

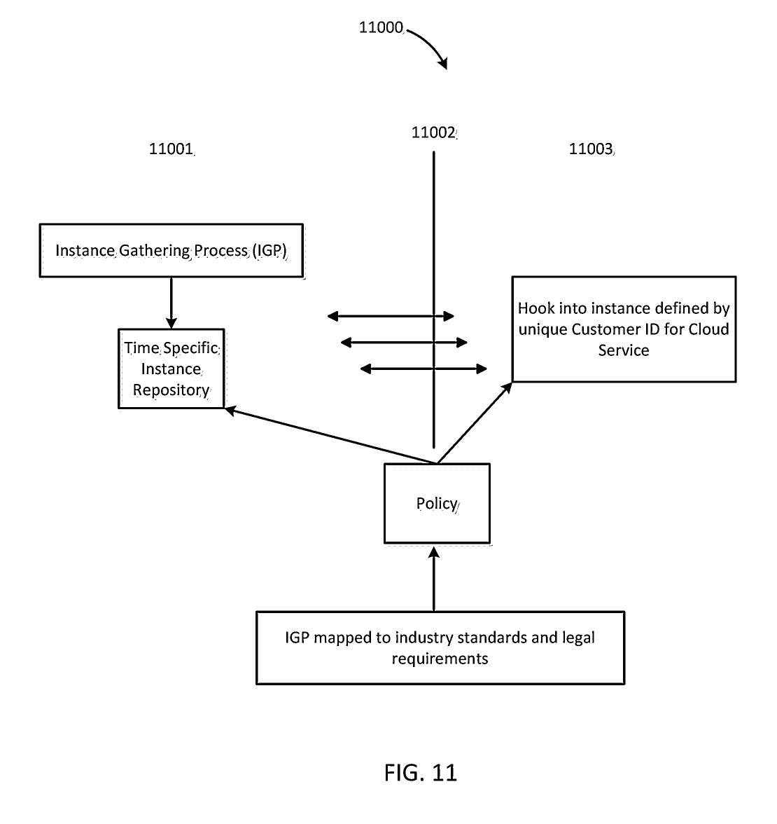

FIG. 11 is an example of how the Instance Gathering Process (IGP) bounded by time stamps 11001 hooks into any one instance undergoing monitoring 11003. These time stamps are mapped to and controlled by a policy with legal and industry standard requirements for security, and compliance and are logically separated by 11002 which is a secure separation with a software firewall embedded, which is referenced in FIG. 1 as 1007; a secured segmentation into the FRaaS platform for a Cloud customer.

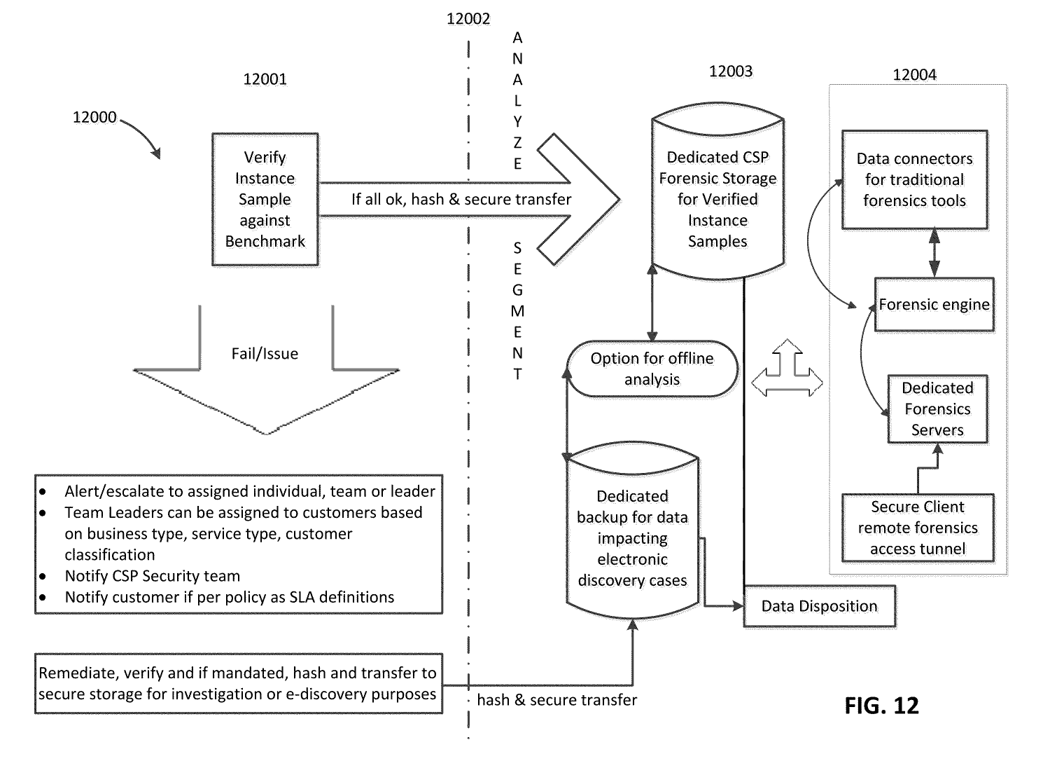

FIG. 12 is an alternative example flow diagram 12000 of a cloud forensic system disclosed herein. This system starts with an Instance Gathering Process (IGP). This system includes securely developed and tested software environments to effectively manage and prevent information leakage. The system can integrate any currently used forensic tools in use today, within block 12004. Connectors built into the system are tool agnostic and may neither touch nor store external data using the cloud FRaaS forensic servers for analysis. In this way investigators can leverage the capacity and functionality of the cloud FRaaS system with relative ease and benefit from the ability to analysis data in less time with more granularity into data analytics bounded by strict chain of custody rules.

A special import/export module allows for offline analysis. This can be leveraged by both external users as defined earlier logging in through a secure API or through the cloud FRaaS platform, block 1020, designated access for investigators; and users executing monitoring within the cloud FRaaS platform. The IGP has built in modules to address timestamps, hashing tools, tools for aggregating access control and centralized log monitoring records. A block 12004 allows external users to access forensic analytics services within the cloud FRaaS system and leverage current industry tools to execute analysis on their own data. They can in turn request access to select functionality within the cloud FRaaS system by submitting a written request approved by either their legal point of contact within their organization or through any other court approved document, if an in progress investigation impacts a current cloud FRaaS customer. As detailed earlier this initiates a ticket being opened and a cloud FRaaS administrator being assigned this case with the ticket number. All processes, legal requests and other legal documentation may be uploaded to this case file bounded by the ticket created with its assigned ticket number and can be subject to independent review by a legal audit team.

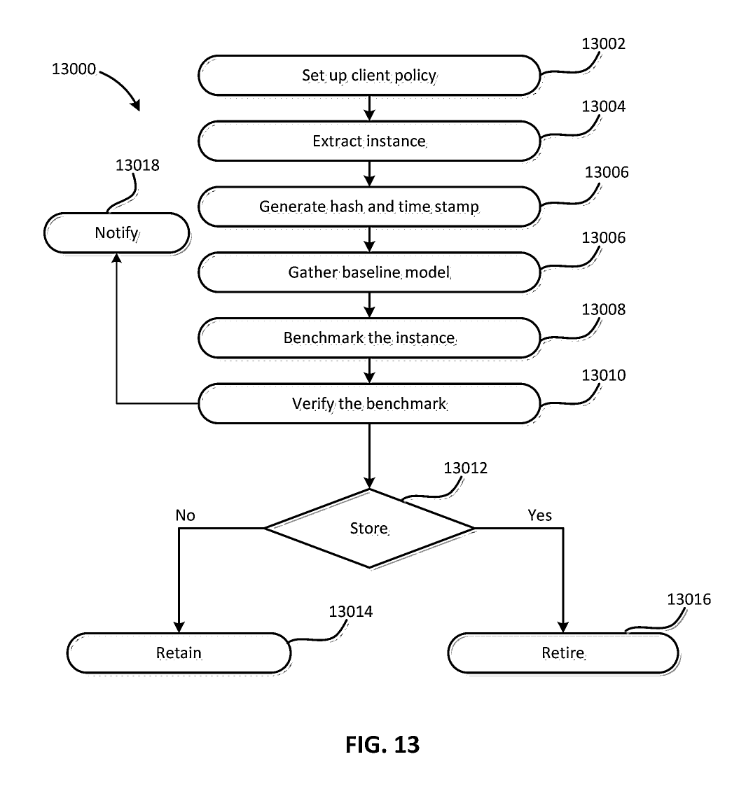

FIG. 13 illustrates an example flowchart 13000 for providing cloud forensics. At operation 13002 once cloud FRaaS administrators are verified and assigned their privileges within the cloud FRaaS system by a cloud FRaaS administrator, they can then proceed to set up their environment within their cloud FRaaS allocation. This may entail setting up policies that meet their requirements per their senior leadership direction, as well as with guidance from their assigned cloud FRaaS administrator. Policy set up and configuration will require tuning within the first month of operations to mitigate false positives and user error within the system. This section may also include setting up user rights, access controls, operational environment and functional alignment with their privilege level. The policies are set up and tuned as directed by the cloud FraaS administrator to ensure best use of the system. Cloud FRaaS is built to meet requirements from NIST, ISO, HIPAA, regulations for the financial and manufacturing industries and the legal arena to name a few. This ensures the security and privacy of confidential to top-secret data. As a result of this, there are policies within the system that map to all related US regulations, US federal and State laws, Canadian law, UK and EU requirements and laws; as well as security and risk from ISO 27001, ISO 27002, ISO 27005, NIST SP 800 series, and PCI-DSS, for example.

An operation 13004 details for extracting an instance have been defined in block 1050 within FIG. 1. In one implementation, the cloud FRaaS platform is built upon to establish a strict chain of custody process—logically. Policy for this process cannot be accessed by any customer user or cloud customer administrator no matter the circumstance. Access to this policy is restricted to a cloud FRaaS administrator and restricted by the process to access such policy. In order to access this policy, the cloud FRaaS administrator receives notification from cloud FRaaS Chief Legal Counsel (CLC). The CLC will authorize the issuance of a time-restricted credential, which is granted to the cloud FRaaS administrator for use as a second authenticating credential in a two-factor login to a restricted area of the policy repository for audit purposes only. In some circumstance and outside any customer environment, time clocking may have to be calibrated, which will occur within this audit process. Within this segment and per the process in block 1050, a user is configured and granted access and authorization by their cloud FRaaS administrator per policy and then provided authorization to “hook” into their cloud environment, select, extract and configure an instance as a benchmark and then begin the process of monitoring instances.

At operation 13006, as per the system setting aligned with a policy mapped to logging and time stamping, a monitoring model baseline is defined. Once an instance is extracted, it will be hashed automatically per system settings and the policy aligned with instance extraction. This hashed instanced instance will be used as a benchmark to define a monitoring model baseline. Instances within the cloud FRaaS system, either extracted or being monitored, are provided a hash of its logs data taken and transferred securely to a physically separated encrypted storage area.

At operation 13008, as stated above a selected hashed instance is defined as a baseline model instance and configured as a benchmark. This benchmark may be used to verify all operations occurring within the selected cloud environment built upon this instance. These baselines are retired periodically based on cloud customer requirements under an automatic process as configured within the cloud FRaaS platform setup process by, both the cloud FRaaS administrator and the cloud customer FRaaS administrator. For a baseline to be retired, an audit is completed on all instances up to the time set for instance retirement to verify the results of no issue found from the instance verification reports.

An operation 13010 performs instance verification, as is detailed in FIG. 6. This is a complex process that is closely monitored by a cloud FRaaS audit team. Verification is an important function of the cloud FRaaS platform and has a larger number of policies within its operation systems. Policy tuning is important to the success within any customer environment as it reduces incidents of false positives and user error. Instances are verified at operation 13010 against a configured benchmark with alerts send to the cloud customer administrator at operation 13018 based on a pre-defined criticality level and risk factor. Once an instance verification process is completed, it is sent to a secure storage area at operation 13012. For verified instances a sample is kept and transferred to a separate long-term encrypted storage area with the rest being retired at operation 13016. For instances that were flagged for investigation or failed verification per policy they are retained, and a hashed copy sent to long-term storage at operation 13014. If they are to be retired it will be in compliance with a policy that defines the time to retire these instances per the cloud customer requirements and their policy for retaining such data.

With regards to timestamps, the system could use The Network Time Protocol (NTP) with main and relay servers. Any system that touches evidence may be configured to this system to ensure accurate time stamping as we engage in an investigation. The cloud provider (CP) may also use the same system to ensure seamless time configurations across various systems and security logs (Net-Flow, web, centralized logging systems etc.).

In one implementation, IGP does not rely on host operating system but rather runs on a separate OS within the segregated Cloud forensic system. With the option of a smart connector an investigator can bypass the CP operating system upon which the virtual environment is built and conduct a reading of the physical disk, in a function totally independent of the virtualized environment being monitored. The software development cycle follows a strict software development process, with security and testing consideration having strong input. This segment followed a strict security process where Development, QA, and production environments are configured in a manner that allows seamless updates or changes across various environments. All update to the change in the Cloud FRaaS operational environments follow a strict change management process with a ticketing system to track and record all changes to the environment.

For example with the development of any custom authentication and session management schemes processes are documented and tested to ensure that proper attention is given to potential flaws in areas such as logout, timeouts and password management.

FIG. 10 illustrates an alternative example flow diagram 10000 of a cloud forensic system disclosed herein. Specifically, FIG. 10 illustrates Cloud forensic system platform and the authentication mechanism. The Cloud forensic system platform depicts at a high level how the system functions with the Application Programming Interface (API)/Graphical User Interfaces (GUI) components at the top layer. This is supported by the second layer services segments where we have policies, security mapping metrics and calculated risk value data.

Due to the ever-growing volumes and types of data, the data may be filtered based on large file types in certain circumstances to make the analysis more manageable and specific to an investigation. For example media files that are transferred or held in cloud environments that are either public or private environments and those files held within social media or other publicly facing ecosystem.

Block 10002 also includes a Cloud Forensics Operational Platform (CFOP), which contains the various import, analysis, process, storage and case management engines. The CFOP also includes a defined Case and Forensics Lifecycle management system augmenting accountability, transparency and the automation of the cloud forensics process. The CFOP also includes the hardware and software systems that contribute to the Cloud forensic system with smart connectors which can allow automated or integrated interaction e.g. (importing log data) with security, legal, e-discovery and risk components.

The Cloud forensic system application manages data movement from the time of initiating a connection into the instance to migrating into the verification module. Built in automation ensures transparency in terms of what data sources are been queried. Also once there is a need for a pipeline to transmit data, the transport functions are configured to protect traffic across various “data in motion” areas by continuously maintaining SSL/TLS protocols.

The emphasis on security as touched on above is to demonstrate that when developing this model the development team works closely with IT Security teams to ensure the integrity of the environment within which data will be analyzed and reported upon for use in any digital forensic investigation.

With regard to authorizations into this system the system allows two primary user types and one secondary user type with restricted access. Authentication credentials for both types are separated via a logical firewall as well as stored physically, from each other. Of the primary user type, there is a further subdivision as follows. The first is an administrator who has root access, the ability to add or delete a user and can track access, usage and time spent within the Cloud forensic system modules. The other will be an investigator who has full control of the system except those functions configured for the administrator.

Both primary users may have clearly defined roles and privileges integrated with role-based encryption polices. For security purposes, the system may use two administrators. This is so that in the event that a client Cloud forensic system administrator gets locked out of the system via remote access, the other administrator can reset the password.

Finally the system provides a secondary user type, which can be created for an analyst, remote for law enforcement personnel on approval from a CP client, or other supportive roles reporting to the primary investigator.

As stated earlier, each client may have a Cloud forensic system identifier and that there may be a separate and secured storage area as shown in FIG. 1. In order to ensure the security of storage encryption keys within the Cloud forensic system each identifier and its related storage key may be stored in an encrypted area within the Cloud forensic system infrastructure. The key is hashed, with a logical separator providing segregated access from the system. This access may have additional credentials governing access, with all identifiers and related storage keys residing in an encrypted state. This process may be owned by the Cloud forensic system administrator and this step augments access control in that only an administrator will be able to access the instances stored within the secured storage area.

For example if the client decides to utilize the system via remote access then the CP Cloud forensic system administrators may not be able to access areas secured by the client's Cloud forensic system administrator without first knowing the administrator password.

Another built in security feature of the IGP is a smart filter that, when configured per policy, detects and block any attempts to initiate an unauthorized session with the IGP. This filter logs any unauthorized attempt to access or change the functionality of the IGP and if a session is not in operation a shutdown sequence is initiated with an automated alert sent to the Cloud forensic system administrator and/or designated security personnel.

With the IGP and the dedicated segment for storage and analysis of data for digital forensics purpose, these concerns can be recognized, managed and controlled. While there may be operational errors as stated, clearly documented cloud security policies and tested processes could contribute to the integrity of the initial forensic instance benchmark. Any event that may impact the cloud ecosystem, once in client execution, can be expected to have minimal adverse impact on the Cloud forensic system segment as the Cloud forensic system is independent of the end-user (client) cloud computing operational ecosystem.

Within block 1050, relevant cloud consumer information is imported from the CP customer database on account sign up. This process may be configured to auto populate once the consumer's information is verified by the CP to save on time and resources. Each consumer is then assigned a cloud forensic ID based on his or her customer ID. Customer IDs are either mapped to an existing customer ID for consumers within a cloud provider ecosystem, or either assigned by the cloud FRaaS administrator based on customer need. Their personal CP and a ranking of forensic risk assigned based on data or actions being executed within the CP's cloud or 2. A unique ID created if the user is providing his own private cloud ecosystem to execute the Forensic as a Service platform internally.

On initial system run, the IGP process initiates and integrates or “hooks” into its assigned customer instance with its assigned forensic identifier, defined and added by a cloud FRaaS administrator. This system is set to run in such a manner that criterion critical for monitoring, capturing and analyzing forensics data, is met within a cloud ecosystem as well as provided an augmented benefit for data from non cloud ecosystems, but have investigators taking advantage of the cloud forensic engines and servers in block 12004. An example of such is the cloud FRaaS forensic risk value, a unique feature of the cloud FRaaS platform. Another example are those aligned with service levels, which conforms to forensic service levels defined in an applicable forensics policy, as well as regulations and compliance metrics which are unique to each consumer or unique to customers in a defined vertical, such as healthcare. These are defined service level agreement (SLA) that is written between the cloud FRaaS and customer legal teams. The IGP is designed to ensure data integrity within a cloud environment, but it expands beyond the cloud and allows integration of data for analysis form a traditional stand alone environment that is under investigation. With the cloud FRaaS platform and easy available through the dashboard administrative settings, are connectors to secure add-ons that are designed to import security data, e.g., centralized log data from a customer environment. These add-on are easily configurable to allow easy import for monitoring and reporting and ensure that any such external security data is imported in a forensically sound manner with integrity of such data maintained as it is captured and imported. All data analyzed will comply with requirements for handling data per data privacy and industry regulatory compliance requirements.

After the IGP completes its primary function, a Cloud forensic system's pre-configured automation process goes on to capture target instances and transfers them to a time specific repository where a verification process is initiated. This storage area is a temporary holding point for the captured data that is held untouched by any other mechanism as it passes onto to the verification process. Instances are held here and sent out to the verification module in a first in first out (FIFO) process for tracking and tagging purposes. However, other order for sending the instances may also be used. Once this verification is completed a hash is taken and logged. Although cloud storage allows for the opportunity of storage scaling, any one investigation will only require specific or finite data for presentation in a court of law as evidence. In light of this a benchmarking process becomes useful in managing, storing and analyzing potential evidence gleaned from the instances gathered.

To further expand on this argument we could assume that within this phase storage requisites required to store instances can grow in volume, becoming unmanageable after some time collecting instances. The cloud forensic system benchmarking process verifies instances as uncorrupted and retires them after a set time period. The retired instances are replaced by more current and verified instances based on prior benchmarking data, which in turn are retired and they get replaced in an Instance Benchmarking Verification Lifecycle (IBVL).

This process reduces the amount instances that an investigator may have to analyze and the length of time he/she will have to go back in time to search for anomalies or hints at a potential malicious activity commencing. By implementing the IBVL, an investigator can be assured that the integrity of retired instances meets legal, regulatory, compliance, content and business metrics. The investigator may then focus on those instances that cause alerts or fail responses within the Cloud forensic system verification process; those instances that have been flagged, tagged securely transferred and stored in an encrypted state in a dedicated storage per a predefined forensics policy.

The CP's internal security and forensics team may have already initiated and completed an investigation on these rogue instances and may have 1) cleared them as false positives or 2) completed other security and forensics actions as warranted and documented results in a findings report.

FIG. 11 illustrates an example flow diagram 11000 of a time specific repository. Once instances have been verified based on set parameters and criteria they are transferred to a CP storage area set aside specifically computer crime investigations. Transmission to storage may be encrypted in motion and any data held in storage or at rest, may be held in an encrypted state. In one implementation, the Cloud forensic system may use metadata tagging within the storage segment, which helps in classification.

For additional security and as a step to maintain the integrity of any data in this process, the encryption keys may be stored separately. Once an instance sample is verified, prior to storage, it will be hashed and then sent to storage. If however the instance exhibits any variation from a benchmark it is being verified against, the system holds it for further investigation and an automated alert sent out to IT Security, Forensics and the Legal teams.

The Cloud forensic system incorporates an incident ticketing integration system to track this alert as well as to seamlessly exchange alert data between the Cloud forensic system and the CP Security and Monitoring system. This can also be configured to update an automated change management system if the alert is valid. The CP's security and risk management team may take corrective action as needed; however the Cloud forensic system log will establish an identifier that will provide a point of reference between systems. This will provided a baseline for synchronizing any ticketing systems managed by the CP, allow seamless data processing and tracking for reporting purposes This point of reference between systems, is also segmented from the “regular” cloud environments and includes additional security (physical and logical) and access control policies and processes to enhance its safety. There is also an automated process with manual oversight, if needed, to retire instances base to a specifically set time criteria under a data disposition operational module.

In designing a tool deployed within a browser for gathering and analysis, a Representational State Transfer REST-compliant API is leveraged in tandem with policies and technologies designed to meet privacy, security, regulatory and compliance metrics. Although one can argue the challenges of security with REST (as with any web-service it is vulnerable to the same attack vectors as standard web applications, such as injection attacks, cross-site scripting (XSS), broken authentication and cross-site request forgery attacks). However API security and secure design methodologies are a key step in the software design process for software modules within the Cloud forensic system. In light of this one step taken to ensure secure transfer and instance or other data integrity lies within the communication between the cloud forensic system modular applications and a Web Services REST API server through Secure Sockets Layer (SSL) encryption.

FIG. 12 illustrates an example flow diagram 12000 of an instance storage management process. Protection against any unauthorized operations is augmented with the utilization of a Cloud forensic system user account-specific token. There are detailed processes that demonstrate the set-up, configuration and management of this process.

An example application of the clouds forensic system disclosed herein is provided below:
Cloud forensic system Case Study

Company Background

XYZ Global Services is a fictional global services organization that specializes in financial transactional services, and consumer retail services where over one million customer credit cards are processed daily. The corporation utilizes proprietary algorithms to gather, analyze and deliver key financial data that can be utilized for logistics, mergers and acquisitions, investments and for financial risk valuations on both corporate and private citizens.

The company employs cutting edge technologies, policies and procedures to ensure that it assures the security, integrity and availability of critical 1 information it processes on a daily basis. Due to its ever increasing needs for processing power and capacity in order to meet these and its business and budgetary requirements the company decided to move some services to the cloud.

XYZ Global Service closed a SLA for both Infrastructure and limited Software-as-a-Service, services with a Cloud Provider six months ago. Part of what was attractive about this CP was their availability of datacenter both in the US and the UK and their knowledge of US-EU Safe Harbor and the EU Directive as XYZ Global processes large amount of data that is considered Personally Identifiable Information (PII).

Business situation

With a large number of instances in use, it was a challenge for the XYZ Global Services security team to get assurance that systems were kept up to date as well as configured properly. Although the CP had a defined cloud security policy and possessed an ISO 27001 certification one concern was that in the event of some malicious event occurring e.g. injecting a root kit to monitor or capture sensitive information executing within the cloud environment the security engineers at XYZ Global Services needed to keep track of which changes had been made, when and by whom and ensure that internal provided attestation that all was in accordance with corporate policy. As the volume of instances grew or instances were simply deleted to better utilize the cloud services, the CISO found it was becoming very time consuming and harder to keep track of the processes in motion as well as to be sure that there were no human errors or potential malicious activity being executed in his cloud environments.

To compound his concern, IT Security had just presented him with a report which detailed the outcome of consumer complaints the occurred within the last ten days, around private consumers being shut off from some financial services due to suspicious activity on their accounts. IT Security reported a potential breach that could have captured data processes within the cloud computing environment and zeroed in on one area of service therein.

The suspicion was that a malicious insider or outsider may have utilized aspects of the cloud service to execute their crime.

The CISO who had been notified of a pilot program at the CP for a Forensics-as-a-Service, add on service had signed a SLA specific to this feature, due to the sensitive and mission critical nature of the business.

Solution

By leveraging the Cloud forensic system residing in a segmented and dedicated environment when a request came in from the CISO of XYZ Global the CP's forensics team may be able to leverage real-time instance gathering capabilities and its forensics analysis features. Due to its intuitive user interface the CP's forensics team can review the automated tracking and verification process and provide the XYZ Global Service forensics team with an initial report that follows a chain of command and defined and authenticated tracking process. If needed, the CP security team can provide remote access to a dedicated storage area where encrypted instances that either failed the automated verification process or violated an element of the cloud forensics policy and was placed for manual review. Due to the presence of this storage area, the team may be able to immediately engage in a forensics review and analysis.

By utilizing the filtering tool, the flagged data for a pre-defined time period (in this case the suggestion is 30 days out) can be selected and imported for offline analysis if necessary or they can simply utilize the forensics servers dedicated for analysis within the CP forensics environment for increased processing speed as well as lower operational cost. The team can also use the same process for importing a sample of verified data for the same time period that was stored within the repository for verified instances.

The concern that any digital forensic team will face a challenge with current forensics tools when attempting to process data dispersed over many storage systems, can be managed by utilizing the verification/benchmark and alert/fail utilities built into the Cloud forensic system model. This will allow an investigator to access a defined and finite subset of data with which to commence an investigation. Data stored in an encrypted state and any access in this state verified at a granular level, with data verified or flagged from any location and stored centrally. Also within the Cloud forensic system Instance Gathering Process (IGP) is module that focused solely on log data and on CP client instance activation and usage; can import data from a centralized logging station, cloud provider access logs, cloud provider NetFlow logs, and the web server virtual machine.

Given the proposed design of the Cloud forensic system with its transparent, automated, secure authentication and encrypted environments the following concerns raised by the legal team can be allayed. Due to the automated IGP, analysis and processing modules, a pattern for an electronic chain of custody can be established throughout the Cloud forensic system model. (The CP was chosen because it housed data enters both in the US and the UK the concern of jurisdiction and conformity with regulatory and privacy concerns were not an issue.)

Can we verify that the cloud provider provided a complete and authentic forensic copy of the data requested?

Is there a defined and repeatable process that can assure the authenticity and integrity of the data and can this process be trusted?

What assurance do we have that the CP's forensic analyst/technician and the tools used to gather data is trusted?

Can the CP provide us with a record of who had access to our data, and how access control was enforced?

How does the CP provide assurance on timestamps consistently across any system involved in this investigation?

Benefits

Manageable costs during the entire forensics process due to the presence of the implemented Cloud forensic system.

Any access to instances/data stored or processed within the Cloud forensic system involves defined user authentication and authorization and a record of access kept in a hashed log.

The Cloud forensic system model requires segregated key management and role based policies, to ensure separation of duties between CP administrators, client administrators and users as well as any third party authorized individuals such as law enforcement.

The presence of the forensics policies and the ability to configure, monitor and update modules, processes and policies with the help of automation provides assurance that the CP with its Cloud forensic system will provide time conscious support during an investigation. This can address no technical legal concerns.

The instance gathering process and benchmarking process will be able to reduce the time spent by the investigator who was able to concentrate of those instances that causes and alert or failed a benchmark approval.

XYZ Global internal forensic analyst may be able to utilize the secured remote application authenticate within the cloud services and gain direct access into the Cloud forensic system. Once remotely in, the investigator was able to leverage the built-in reporting and analytic tools for parsing, searching and extracting information stored within the dedicated storage for instances that caused an alert without interrupting or having to touch their running cloud services.

The concerns of forensic metadata from the CP environment can be allayed by the module that implements “the instance verification against an established sample” process which is then securely transmitted and stored in an encrypted form. Access control to this stored data is heavily monitored and controlled. The argument here is that verified instances stored securely without evidence of a crime can be used to support a forensic investigation, once it has been established a crime has been committed.

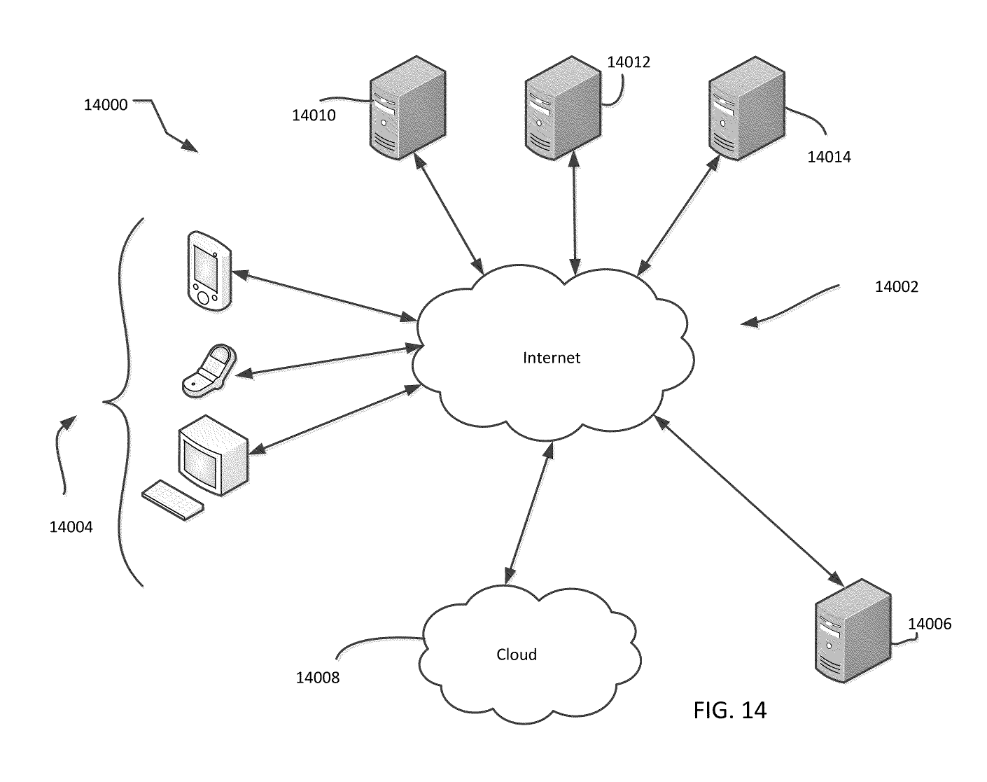

FIG. 14 illustrates an example network environment 14000 for implementing the cloud forensics system described herein. Specifically, FIG. 14 illustrates a communications network 14002 (e.g., the Internet) that is used by one or more computing or data storage devices for implementing the system for information cataloging. In one implementation, one or more user devices 14004 are communicatively connected to the communications network 14002. Examples of the user devices 14004 include a personal computer, a laptop, a smart-phone, tablet or slate (e.g., iPad), etc. A user interested in the information cataloging uses such user devices 14004 to access the system for information cataloging. The network 14002 may be connected to various servers 14006, 14010, 14012, 14014, etc.

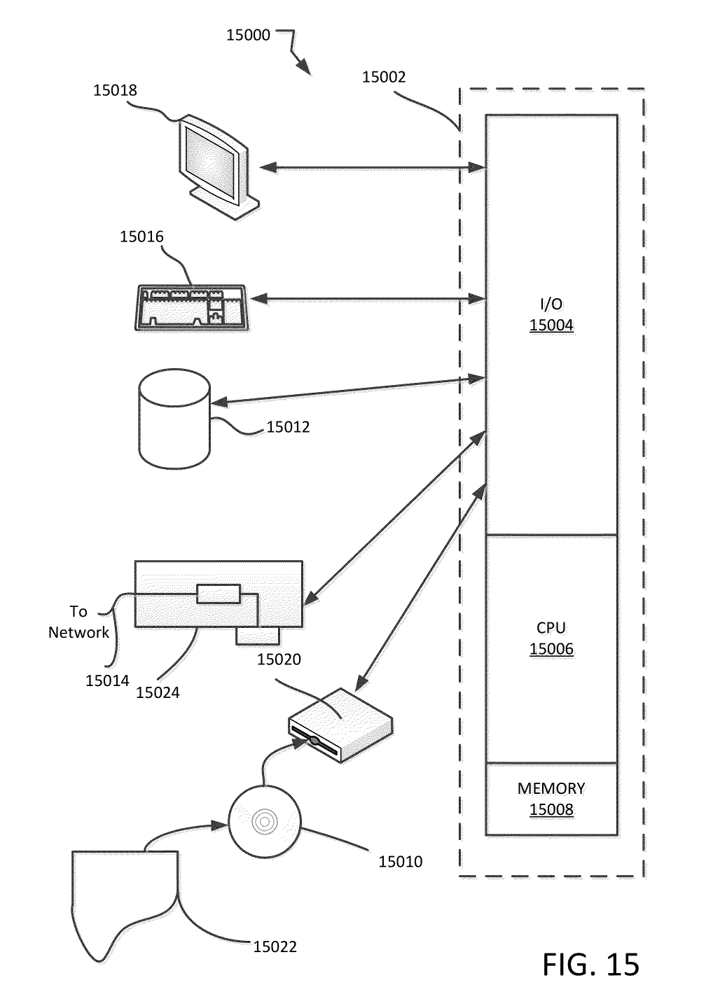

FIG. 15 illustrates an example computing system that can be used to implement one or more components of the cloud forensics method and system described herein. A general-purpose computer system 15000 is capable of executing a computer program product to execute a computer process. Data and program files may be input to the computer system 15000, which reads the files and executes the programs therein. Some of the elements of a general-purpose computer system 15000 are shown in FIG. 12, wherein a processor 15002 is shown having an input/output (I/O) section 15004, a Central Processing Unit (CPU) 15006, and a memory section 15008. There may be one or more processors 15002, such that the processor 15002 of the computer system 15000 comprises a single central-processing unit 15006, or a plurality of processing units, commonly referred to as a parallel processing environment. The computer system 15000 may be a conventional computer, a distributed computer, or any other type of computer such as one or more external computers made available via a cloud computing architecture. The described technology is optionally implemented in software devices loaded in memory 15008, stored on a configured DVD/CD-ROM 15010 or storage unit 15012, and/or communicated via a wired or wireless network link 15014 on a carrier signal, thereby transforming the computer system 15000 in FIG. 15 to a special purpose machine for implementing the described operations.

The I/O section 15004 is connected to one or more user-interface devices (e.g., a keyboard 15016 and a display unit 15018), a disk storage unit 15012, and a disk drive unit 15020. Generally, in contemporary systems, the disk drive unit 15020 is a DVD/CD-ROM drive unit capable of reading the DVD/CD-ROM medium 15010, which typically contains programs and data 15022. Computer program products containing mechanisms to effectuate the systems and methods in accordance with the described technology may reside in the memory section 15004, on a disk storage unit 15012, or on the DVD/CD-ROM medium 15010 of such a system 15000, or external storage devices made available via a cloud computing architecture with such computer program products including one or more database management products, web server products, application server products and/or other additional software components. Alternatively, a disk drive unit 15020 may be replaced or supplemented by a floppy drive unit, a tape drive unit, or other storage medium drive unit. The network adapter 15024 is capable of connecting the computer system to a network via the network link 15014, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based, or other operating system. It may be understood that computing systems may also embody devices such as Personal Digital Assistants (PDAs), mobile phones, smart-phones, gaming consoles, set top boxes, tablets or slates (e.g., iPads), etc.

When used in a LAN-networking environment, the computer system 15000 is connected (by wired connection or wirelessly) to a local network through the network interface or adapter 15024, which is one type of communications device. When used in a WAN-networking environment, the computer system 15000 typically includes a modem, a network adapter, or any other type of communications device for establishing communications over the wide area network. In a networked environment, program modules depicted relative to the computer system 15000 or portions thereof, may be stored in a remote memory storage device. It is appreciated that the network connections shown are exemplary and other means of and communications devices for establishing a communications link between the computers may be used.

Further, the plurality of internal and external databases, data stores, source database, and/or data cache on the cloud server are stored as memory 15008 or other storage systems, such as disk storage unit 15012 or DVD/CD-ROM medium 15010 and/or other external storage device made available and accessed via a cloud computing architecture. Still further, some or all of the operations for the system for recommendation disclosed herein may be performed by the processor 15002. In addition, one or more functionalities of the system disclosed herein may be generated by the processor 15002 and a user may interact with these GUIs using one or more user-interface devices (e.g., a keyboard 15016 and a display unit 15018) with some of the data in use directly coming from third party websites and other online sources and data stores via methods including but not limited to web services calls and interfaces without explicit user input.

Embodiments of the present technology are disclosed herein in the context of a recommendation system. In the above description, for the purposes of explanation, numerous specific details are set forth in order to provide a thorough understanding of the present invention. It will be apparent, however, to one skilled in the art that the present invention may be practiced without some of these specific details. For example, while various features are ascribed to particular embodiments, it may be appreciated that the features described with respect to one embodiment may be incorporated with other embodiments as well. By the same token, however, no single feature or features of any described embodiment should be considered essential to the invention, as other embodiments of the invention may omit such features.

In the interest of clarity, not all of the routine functions of the implementations described herein are shown and described. It will, of course, be appreciated that in the development of any such actual implementation, numerous implementation-specific decisions are made in order to achieve the developer's specific goals, such as compliance with application—and business-related constraints, and that those specific goals will vary from one implementation to another and from one developer to another.

According to one embodiment of the present invention, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

According to one embodiment of the present invention, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Washington, Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines; and. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In the context of the present invention, the term “processor” describes a physical computer (either stand-alone or distributed) or a virtual machine (either stand-alone or distributed) that processes or transforms data. The processor may be implemented in hardware, software, firmware, or a combination thereof.

In the context of the present technology, the term “data store” describes a hardware and/or software means or apparatus, either local or distributed, for storing digital or analog information or data. The term “Data store” describes, by way of example, any such devices as random access memory (RAM), read-only memory (ROM), dynamic random access memory (DRAM), static dynamic random access memory (SDRAM), Flash memory, hard drives, disk drives, floppy drives, tape drives, CD drives, DVD drives, magnetic tape devices (audio, visual, analog, digital, or a combination thereof), optical storage devices, electrically erasable programmable read-only memory (EEPROM), solid state memory devices and Universal Serial Bus (USB) storage devices, and the like. The term “Data store” also describes, by way of example, databases, file systems, record systems, object oriented databases, relational databases, SQL databases, audit trails and logs, program memory, cache and buffers, and the like.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A method, comprising:
generating an instance from a client cloud computing environment, wherein the instance is generated without affecting the integrity of the client cloud computing environment;
generating a baseline of the client cloud computing environment;
benchmarking the instance based on comparison of the instance to the baseline;
verifying the benchmark based on a client policy; and
retiring the instance, if the benchmark is verified.

2. The method of claim 1, further comprising retaining the benchmark if it is not verified.

3. The method of claim 1, further comprising reporting the report the status of the instance verification to an authority, if the instance verification has failed.

4. The method of claim 1, wherein generating the instance further comprises generating the instance without altering the metadata and data associated with client cloud computing environment.

5. The method of claim 1, wherein generating the instance further comprises hashing the instance and time-stamping the instance.

6. The method of claim 1, wherein generating the instance further comprises generating the instance based on a client policy.

7. A cloud forensic system, comprising:
an instance gathering module (IGP) configured to extract instances from a client cloud environment while maintaining the integrity of the client cloud environment;
a baseline module configured to generate a baseline of the client cloud environment based on a client policy;
a benchmarking module configured to generate benchmarks based on comparison of each of the instances with the baseline;
a verification module configured to verify the benchmark;
a retirement module configured to retire one or more of the instances;
a retention module configured to retain one or more of the instances; and
a reporting module configured to report the one or more non-verified instances.

8. The system of claim 1, wherein the verification module is further configured to verify the benchmark based on the client policy.

9. The system of claim wherein the retirement module is configured to retire the one or more of the instances if they are verified.

10. The system of claim wherein the retention module is configured to retain the one or more of the instances if they are not verified.

11. A non-transitory computer-readable storage medium having computer-executable instructions comprising:
generating an instance from a client cloud computing environment;
generating a baseline of the client cloud computing environment;
benchmarking the instance based on comparison of the instance to the baseline;
verifying the benchmark based on a client policy; and
retiring the instance, if the benchmark is verified.

12. The non-transitory computer-readable storage medium of claim 11, wherein the instance is generated without affecting the integrity of the client cloud computing environment.

13. The non-transitory computer-readable storage medium of claim 11, further comprising retaining the benchmark if it is not verified.

14. The non-transitory computer-readable storage medium of claim 11, further comprising reporting the report the status of the instance verification to an authority, if the instance verification has failed.

15. The non-transitory computer-readable storage medium of claim 11, wherein generating the instance further comprises generating the instance without altering the metadata and data associated with client cloud computing environment.

16. The non-transitory computer-readable storage medium of claim 11, wherein generating the instance further comprises hashing the instance and time-stamping the instance.

17. The non-transitory computer-readable storage medium of claim 11, wherein generating the instance further comprises generating the instance based on a client policy.
